(19) United States
(12) Patent Application Publication
(10) Pub. No.: US 2026/0363522 A1
(43) Pub. Date: Nov. 19, 2026

(54) Spray Arm for Cleaning Machine, and Cleaning Machine

(71) Applicant: Ningbo Fotile Kitchen Ware Co., Ltd., Ningbo, Zhejiang (CN)

(72) Inventors: Feng Zheng, Ningbo (CN); Benzhu Wei, Ningbo (CN)

(21) Appl. No.: 19/135,474

(22) PCT Filed: Dec. 12, 2023
(86) PCT No.: PCT/CN2023/138092

§ 371 Date: Jun. 4, 2025

(30) Foreign Application Priority Data
Dec. 12, 2022 (CN) 202211599736.6
Dec. 12, 2022 (CN) 202211611048.7
Dec. 12, 2022 (CN) 202223362585.0

(51) Int. Cl. A47L 15/22; A47J 43/24

(52) U.S. Cl. CPC A47L 15/22; A47J 43/24

(57) ABSTRACT

A spray arm for a cleaning machine comprises a spray arm body and one or more nozzles. The spray arm body has a plurality of water spray holes and one or more water outlets. Each nozzle is rotatably disposed on the spray arm body and communicates with one corresponding water outlet. Each nozzle has one or more ejecting apertures. An air layer is formed adjacent to the periphery wall of each nozzle and surrounds the one or more ejecting apertures to supply air to an ejecting water column passing through each ejecting aperture, so as to form an ejecting water column with bubbles ejected from each ejecting aperture. A cleaning machine using the spray arm is also disclosed. The spray arm has the nozzles each being capable of rotating together with the spray arm, so it is advantageous for eliminating the hard-to-reach corners to be cleaned.

### TECHNICAL FIELD OF THE INVENTION

The present invention relates to a technical field of dishwashers, and in particular to a spray arm for a cleaning machine and a cleaning machine thereof which can clean dishes, fruits and vegetables.

### BACKGROUND OF THE INVENTION

Dishwashers are generally equipped with spray arms that spray water columns to wash dishes or fruits and vegetables. For example, both a Chinese Utility Model CN204813755U (application No.: CN201520531714.5) entitled SPRAY ARM SEAT FOR DISHWASHER, SPRAY ARM DEVICE FOR DISHWASHER, AND DISHWASHER and a Chinese Utility Model CN209932651U (application No.: CN201920258610.X) entitled SPRAY ARM FOR CLEANING MACHINE disclosed corresponding spray arms.

With regard to the above-stated spray arm which has two sidewalls, the spray arm has a water inlet on one sidewall of the spray arm, and water is discharged to both sides through the water inlet. The spray arm is driven to rotate by the viscous force dispersed in the flow channel by water. The spray arm has first water spray holes for spraying water columns on another sidewall of the spray arm. In the existing dishwashers, after the dish rack is fixed in place, the positions of dishes on the dish rack are unchanged, but the water columns sprayed by the spray arm is roughly straight (strip-shaped), so that the spraying range of the water columns is limited and the surfaces of all dishes cannot be covered, so that hard-to-reach corners to be cleaned are occurred and the cleaning effect is affected. Moreover, for dishwashers with rectangular washing chambers, it is also easy to create the hard-to-reach corners to be cleaned.

A Chinese Utility Model CN204445748U (application No.: CN201520047405.0), entitled SPRAYER FOR DISHWASHER AND DISHWASHER disclosed a sprayer comprising a water storage chamber, a spraying surface and a mounting surface; wherein, the sprayer has a plurality of spray holes each communicating with the water storage chamber on the spraying surface, a water inlet and a nozzle on the mounting surface of the sprayer. The nozzle has at least two nozzle spray holes and a water channel communicating with the water storage chamber. Each nozzle spray holes communicates with the water channel. When the sprayer rotates for spraying, the nozzle on the sprayer also sprays water. Since the nozzle has at least two nozzle spray holes, the effective spraying area is increased, and the hard-to-reach corners to be cleaned are reduced.

The above-stated sprayer is benefit for reducing the hard-to-reach corners, but the water columns spraying from the nozzle have poor cleaning performance due to partial energy loss.

### SUMMARY OF THE INVENTION

It is an object of the present invention to provide a spray arm for a cleaning machine, which can effectively eliminate the hard-to-reach corners to be cleaned, improve the stripping force of ejecting water columns to pollutants, so as to improve the cleaning effect. It is another object of the present invention to provide a cleaning machine thereof.

For achieving the above object, the spray arm comprises:
a spray arm body having a top surface and two ends; one or more nozzles each having a periphery wall; wherein, the spray arm body has a plurality of water spray holes and one or more water outlets, each nozzle is rotatably disposed on the spray arm body and communicates with one corresponding water outlet; each nozzle has one or more ejecting apertures, an air layer is formed adjacent to the periphery wall of each nozzle and surrounds the one or more ejecting apertures to supply air to an ejecting water column passing through each ejecting aperture, so as to form an ejecting water column with bubbles ejected from each ejecting aperture.

Preferably, a top cover spaced apart from the periphery wall of each nozzle is connected to each nozzle, the top cover has one or more ejecting holes each facing the corresponding ejecting aperture of each nozzle below; a second gap for allowing air to be sucked into the ejecting water column from each ejecting aperture in an ejecting state is formed between each ejecting hole and the corresponding ejecting aperture. Thus, a gap between a bottom surface of the top cover and top surfaces of the one or more nozzles are defined as the air layer, and the second gap is located within the air layer.

Preferably, the spray arm body has a top surface, an air collection chamber is formed at the top surface of the spray arm body, the air collection chamber surrounds the plurality of water spray holes to supply air to a spraying water column passing through each water spray hole, so as to add bubbles to each spray water column from each water spray hole.

Preferably, the spray arm body has a lengthwise direction and a middle portion, two nozzles are respectively disposed at each end of the spray arm body in the same direction lengthwise of the spray arm body, the air collection chamber extends from the middle portion to two ends of the spray arm body and is located between the two nozzles.

Preferably, the spray arm body has a hollow flow channel communicating with the one or more water outlets, the spray arm body has one or more mounting recesses each for receiving the corresponding nozzle, and each mounting recess has a semi-enclosed edge and an opening opposite to the semi-enclosed edge. Thus, the spray arm can effectively eliminate the hard-to-reach corners to be cleaned, and can wash away silts and food residues in the fitting clearance so as to ensure a smoother rotation of each nozzle.

Preferably, the opening of each mounting recess exposes a part of the annular periphery wall of each nozzle mounted on the corresponding mounting recess, an arc length of the exposed part of each annular periphery wall of each nozzle is 20% to 80% of a circumferential length of each nozzle, further preferably 30% to 50% of the circumferential length of each nozzle.

Preferably, the mounting recess is located at each end of the spray arm body, the opening of each mounting recess faces outside from the end of the spray arm body.

Preferably, the spray arm body has the plurality of water spray holes, the one or more nozzles, and the one or more mounting recess on the top surface of the spray arm body; each mounting recess having the semi-enclosed edge is formed between an end of the air collecting chamber and an outer end wall of the spray arm body; each mounting recess has the one or more water outlets on a bottom of the mounting recess; and, each nozzle is rotatably disposed in the corresponding mounting recess.

Preferably, each nozzle is disc-shaped, each end of the spray arm body is formed into an arc-shaped end wall corresponding to an outer edge of the nozzle which is located above the spray arm body; the top plate has two end portions, and each end portion of the top plate is recessed inward to form an arc-shaped notch that partially surrounds the nozzle and matches the nozzle, the mounting recess is partially enclosed by the arc-shaped notch and the top wall of the spray arm body on an outer side of the spray arm body.

Preferably, the opening of each mounting recess is defined as an air inlet of the air collection chamber. Under such a design, after each nozzle is mounted on the spray arm, the spray arm has good integrity, and the following effects are mainly achieved. Firstly, the rotation of the nozzle is guided along a circumferential direction, so that the stability of the rotation of the nozzle is improved. Secondly, because of the semi-enclosed edge and the annular opening of each mounting recess, food residues and silts can be washed away through the opening of the mounting recess by the rotation of the nozzle, so that the pollutant accumulation is avoided, the fitting clearance between an edge of the nozzle and an edge of a top plate can be reduced, and the stability of the rotation of the nozzle can be further improved. Thirdly, the periphery wall of each nozzle can also block an air inlet region of the air collecting chamber, so as to prevent the washing water and pollutants from entering into the air collecting chamber.

Preferably, a top plate spaced apart from the top surface of the spray arm body is disposed on the spray arm body, the air collection chamber is defined between the top plate and the top surface of the spray arm body; the top plate has a plurality of jet holes each corresponding to each of the plurality of water spray holes, a first gap is formed between each jet hole and the corresponding water spray hole for allowing air to be sucked into the spray water column passing through each water spray hole in a spraying state; the air collection chamber, the plurality of jet holes and the first gap form a first air entrapping mechanism. According to the Venturi effect, when the water column passes through the water spray holes and the jet holes, negative pressure will be generated in the first gap, so that air around the water column will be sucked into the water column to form a spray water column with bubbles. When the spray water column hits a surface of the object to be cleaned, the stripping force to the pollutants can be increased at the moment when the bubbles are broken, thus improving the cleaning effect.

Preferably, the plurality of spray holes and the second gap form a second air entrapping mechanism for forming a spray water column with bubbles sprayed from each spray hole. Similarly, according to the Venturi effect, when the water column passes through the ejecting apertures and the ejecting holes, negative pressure will be generated in the second gap, so that air around the water column will be sucked into the water column to form the spray water column with bubbles. When the spray water column hits a surface of the object to be cleaned, the stripping force to the pollutants can be increased at the moment when the bubbles are broken. A spray water column with bubbles is formed by the spray arm body under the first air entrapping mechanism, and another spray water column with bubbles is formed by the nozzle under the second air entrapping mechanism. Thus, the cleaning effect is further improved through the double air entrapping mechanisms.

Preferably, a plurality of support ribs for supporting the top plate on the spray arm body is disposed below the top plate.

Preferably, at least a portion of each support rib is arc-shaped and extends along an edge of the arc-shaped notch below the top plate, each support rib has two ends and a gap for allowing air to enter the air collecting chamber from the outside exists between at least one end of the support rib and an inner wall of the air collecting chamber.

Preferably, the spray arm body has an inclined diversion plane at each end of the spray arm body which gradually inclines downward radially from an edge of a top of the arc-shaped end wall.

Preferably, a top surface of the top cover is gradually inclined downward from a center to a periphery to form a flow-guiding surface.

Preferably, each nozzle has at least two ejecting apertures.

Preferably, each nozzle is disc-shaped, and the plurality of ejecting apertures is arranged obliquely on a top surface of the nozzle at intervals along the circumferential direction.

Preferably, each nozzle has a water inlet and a water inlet sleeve extending downward and surrounding the water inlet on a bottom of the nozzle, and the water inlet sleeve is rotationally connected to a water outlet through buckles.

Preferably, one or more clamping pins are disposed at a bottom edge of the nozzle. Each clamping pin can pass through the corresponding water outlet to resist against a top wall of a flow channel so as to make the nozzle be rotationally disposed on the spray arm body.

Preferably, an outer sidewall of each clamping pin is gradually inclined outward from top to bottom in a radial direction to form a flow-guiding slope, reducing energy loss of fluid entering the nozzle in the flow channel.

Preferably, when the spray arm is fully assembled, a top surface of each nozzle is flush with the top surface of the spray arm body. Or, when the spray arm is fully assembled, a thickness of the nozzle is 0.5 to 1.5 times of a depth of the semi-enclosed mounting recess. Thus, the spray arm has stable structure, anti-blocking effect of the nozzle, and aesthetic appearance.

For achieving another object of the present invention, the cleaning machine comprises a box having a bottom and the spray arm; wherein, the spray arm is rotatably disposed inside the box.

Preferably, the cleaning machine further comprises a filter plate, the box has a water return region recessed downward from a bottom of the box, the filter plate covers the water return region, and the spray arm is located above the filter plate. In addition, the spray arm communicates with the water return region through a water pumping mechanism.

The cleaning machine is a dishwasher or a fruit and vegetable cleaning machine.

Compared with the prior art, the spray arm for a cleaning machine of the present invention has the following advantages. The spray arm has the one or more nozzles each being capable of rotating together with the spray arm and rotating relative to the spray arm, so it is advantageous for eliminating the hard-to-reach corners to be cleaned. The water column with bubbles sprayed out is formed through the air entrapping mechanisms, and the bubbles in the water flow will be broken at the moment when the water column with bubbles comes into contact with pollutants, so that the stripping force to the pollutants on the surface of the object to be cleaned can be increased, and the cleaning effect can be improved. Moreover, since each nozzle is disposed outside the top plate, it can avoid sheltering food residues and silts at a gap between each nozzle and the top plate, and the stability of the rotation of the nozzle can be improved.

The cleaning machine of the present invention also has the above advantages.

### BRIEF DESCRIPTION OF THE DRAWINGS

FIG. 1 is a top plane view of a cleaning machine according to an embodiment of the present invention;

FIG. 2 is a perspective view of a spray arm according to the embodiment of the present invention;

FIG. 3 is another perspective view of the spray arm seen from the bottom of FIG. 2;

FIG. 4 is a partially exploded view of the spray arm according to the embodiment of the present invention;

FIG. 5 is an exploded view of the spray arm according to the embodiment of the present invention;

FIG. 6 is a partially enlarged view of FIG. 5;

FIG. 7 is a sectional view of a part of the spray arm according to the embodiment of the present invention;

FIG. 8 is a perspective view of the nozzle seen from the bottom according to the embodiment of the present invention.

### DETAILED DESCRIPTION OF THE INVENTION

The present invention will be further described below in detail by embodiments with reference to the accompanying drawings.

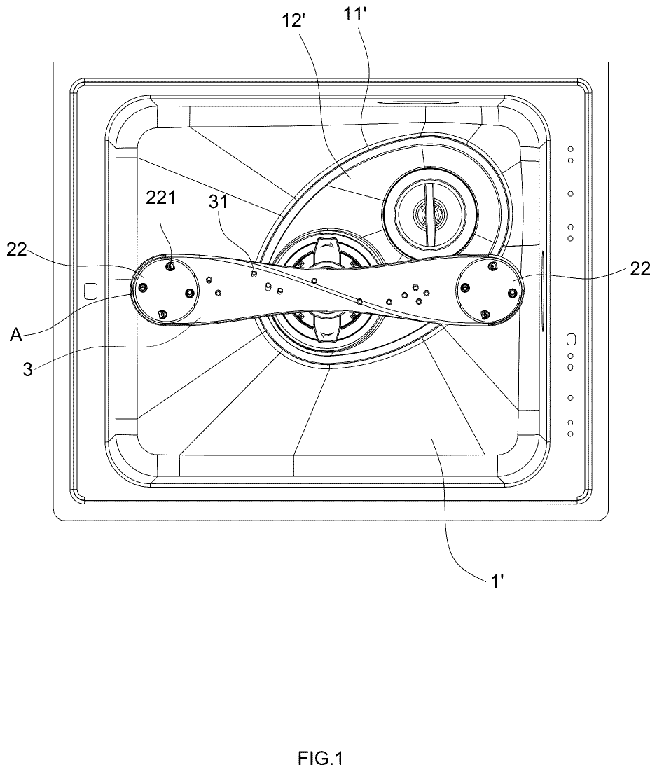

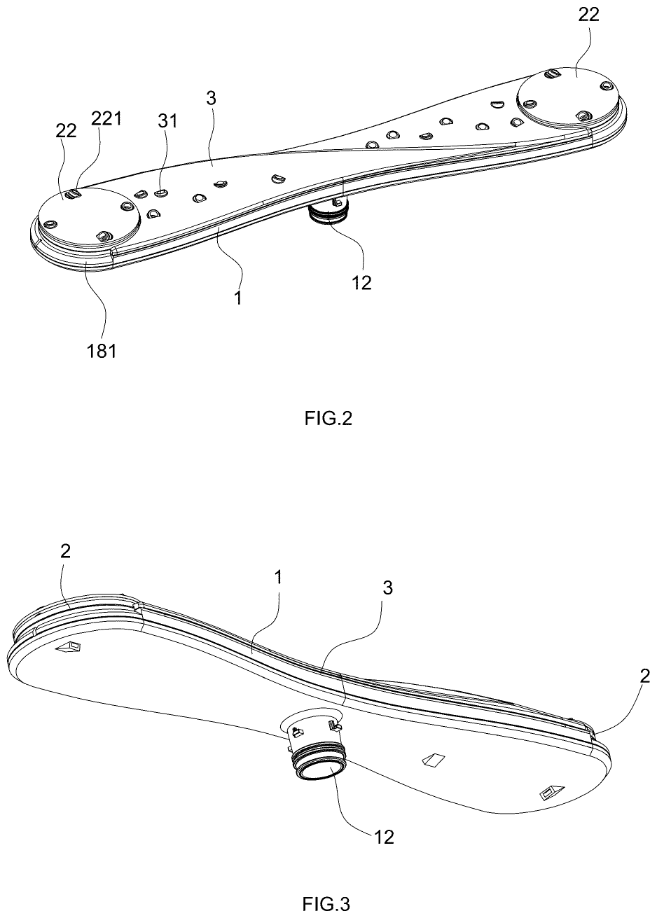

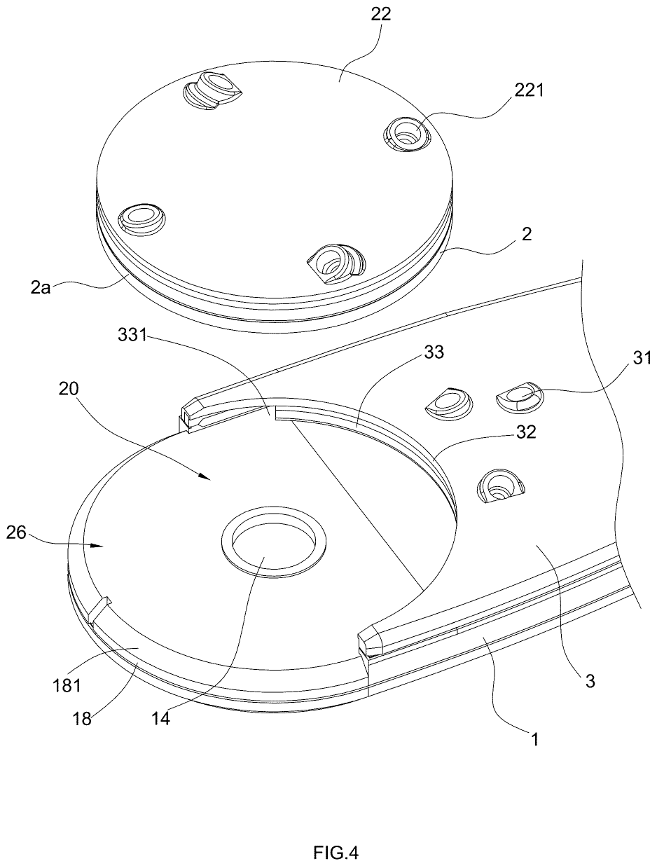

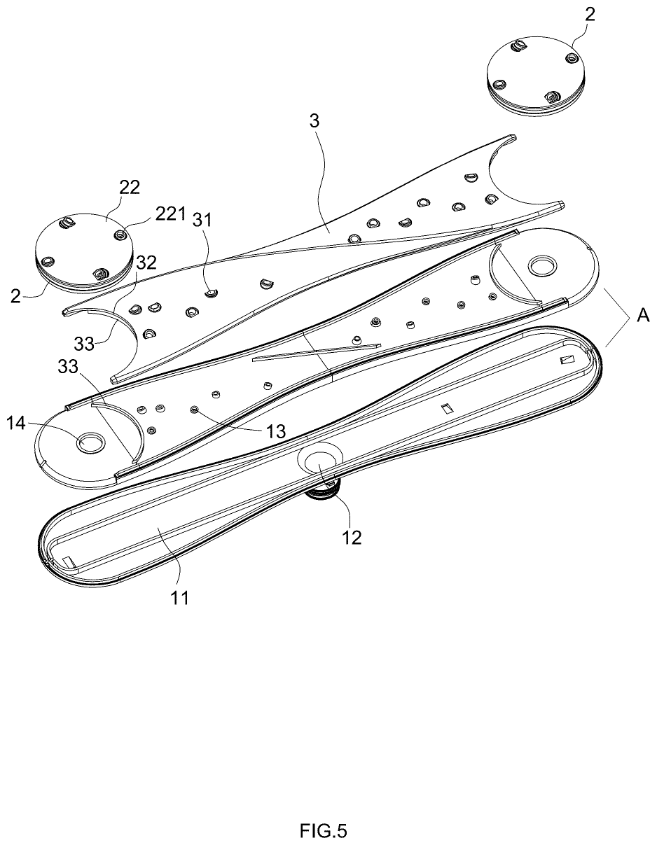

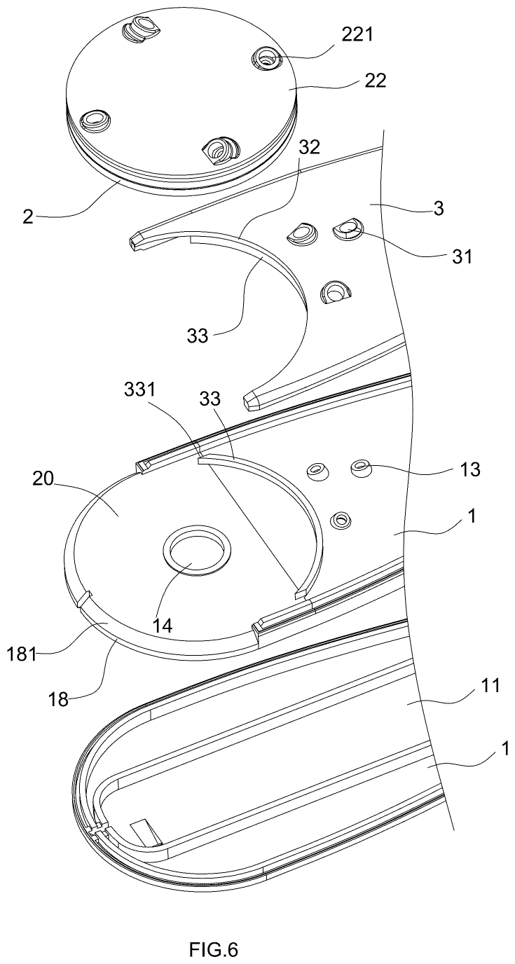

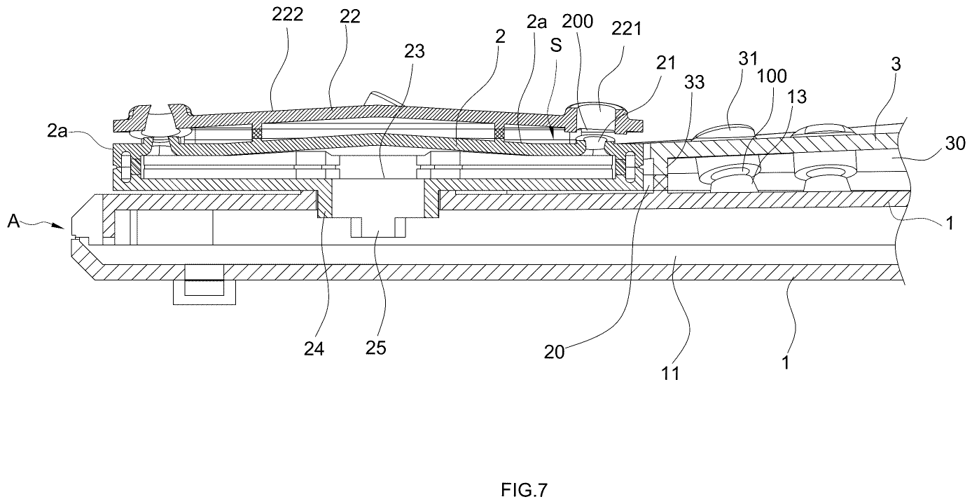

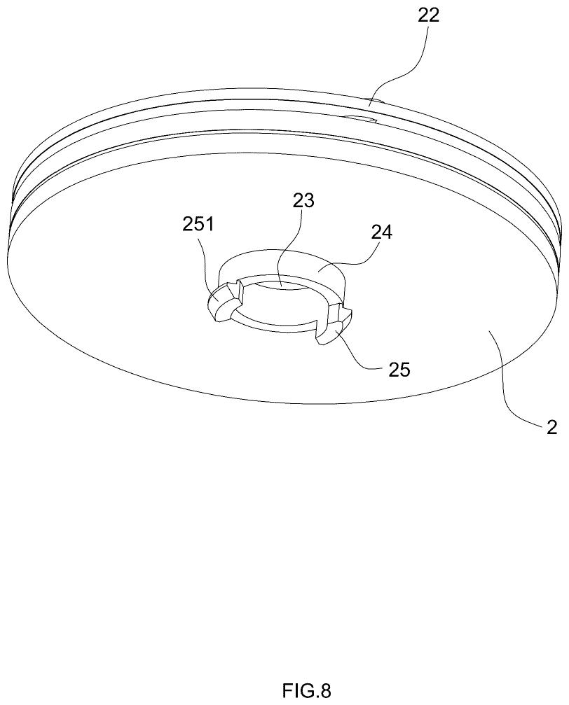

FIGS. 1-8 show a preferred embodiment of a cleaning machine of the present invention. The cleaning machine in this embodiment comprises a box 01 having a bottom and a spray arm A having a top surface and a bottom surface. The spray arm A comprises a spray arm body 1 having a top surface and two ends, a top plate 3 and two nozzles 2. The cleaning machine comprises a filter plate 012. The box 01 has a water return region 011 recessed downward from the bottom of the box 01. The filter plate 012 covers the water return region 011. A water pump communicating with the water return region 011 is disposed in the water return region 011. The water pump has a water outlet facing upward. The spray arm A is located above the filter plate 012 and communicates with the water outlet of the water pump.

The spray arm A is rotatably disposed inside the box 01 and disposed adjacent to the bottom of the box 01. The spray arm body 1 has a hollow flow channel 11 which extends along a length of the spray arm body 1. The spray arm body 1 has a water inlet 12 on the bottom surface, and a plurality of water spray holes 13 on the top surface of the spray arm body 1. Both the water inlet 12 and the plurality of water spray holes 13 communicate with the flow channel 11. A water pump mechanism (that is, the water pump, which is invisible in FIG. 1 since it is covered by the filter plate 012) for pumping water on the bottom of the box 01 into the flow channel 11 through the water inlet 12 is disposed at the bottom of the box 01.

The spray arm body 1 is formed by combining an upper housing and a lower housing. The top plate 3 is covered above the spray arm body 1, and an air collecting chamber 30 is defined between the top plate 3 and the top surface of the spray arm body 1. The air collecting chamber 30 communicates with external air. The top plate 3 has a plurality of jet holes 31 each corresponding to each of the plurality of water spray holes 13. A first gap 100 is formed between each jet hole 31 and the corresponding water spray hole 13 for allowing air to be sucked into the spray water column passing through each water spray hole 13 in a spraying state. The air collection chamber 30, the plurality of jet holes 31 and the first gap 100 form a first air entrapping mechanism. According to the Venturi effect, when the water column passes through the water spray holes 13 and the jet holes 31, negative pressure will be generated in the first gap 100, so that air around the water column will be sucked into the water column to form a spray water column with bubbles. When the spray water column hits a surface of the object to be cleaned, the stripping force to the pollutants can be increased at the moment when the bubbles are broken, thus improving the cleaning effect.

In this embodiment, the spray arm body 1 has two water outlets 14 each being located on the top surface of the spray arm body 1 and being located adjacent to each of the two ends of the spray arm body 1. Each water outlet 14 communicates with one corresponding nozzle 2. Two nozzles 2 each having a periphery wall 2a are respectively located at the two ends of the top plate 3, so that each nozzle 2 locates at the side of the top plate 3, it can avoid a gap between each nozzle 2 and the top plate 3 which will shelter food residues and silts to affect the rotation of the nozzle smoothly.

Specifically, each nozzle 2 is disc-shaped. Each end of the spray arm body 1 is formed into an arc-shaped end wall 18 corresponding to an outer edge of the nozzle 2 which is located above the spray arm body 1. The top plate 3 has two end portions, and each end portion of the top plate 3 is recessed inward to form an arc-shaped notch 32 that partially surrounds the nozzle 2 and matches the nozzle 2. The spray arm body 1 has two mounting recesses 20 each for receiving the corresponding nozzle 2, and each mounting recess 20 has a semi-enclosed edge and an opening opposite to the semi-enclosed edge. The mounting recess 20 is partially enclosed by the arc-shaped notch 32 and the top wall of the spray arm body 1 on an outer side of the spray arm body 1. A region that each mounting recess 20 locates and is bordered by the arc-shaped end wall 18 is defined as an air inlet of the air collection chamber 30. Under such a design, after each nozzle 2 is mounted on the spray arm body 1, the spray arm body 1 has good integrity, and the following effects are mainly achieved. Firstly, the rotation of the nozzle 2 is guided along a circumferential direction, so that the stability of the rotation of the nozzle 2 is improved. Secondly, because of the semi-enclosed edge and the annular opening of each mounting recess 20, food residues and silts can be washed away through the opening of the mounting recess 20 by the rotation of the nozzle 2, so that the pollutant accumulation is avoided, the fitting clearance between an edge of the nozzle 2 and an edge of a top plate 3 can be reduced, and the stability of the rotation of the nozzle 2 can be further improved. Thirdly, the periphery wall of each nozzle 2 can also block an air inlet region of the air collecting chamber 30, so as to prevent the washing water and pollutants from entering into the air collecting chamber 30.

A plurality of support ribs 33 supports the top plate 3 on the top surface of the spray arm body 1. Each support rib 33 is arc-shaped and extends along an edge of the arc-shaped notch 32 below the top plate 3. Each support rib 33 has two ends and a gap 331 for allowing air to enter the air collecting chamber 30 from the outside exists between two ends of the support rib 33 and an inner wall of the air collecting chamber 30. On one hand, the above design provides support for the top plate 3; on the other hand, the above design further blocks an air inlet region and prevents the washing water and pollutants from entering the air collecting chamber 30.

The spray arm body 1 has an inclined diversion plane 181 at each end of the spray arm body 1 which gradually inclines downward radially from an edge of a top of the arc-shaped end wall 18, so that it is convenient for a quick drainage of the accumulated water at each nozzle 2.

The nozzle 2 has a hollow disc-shaped or cross-shaped flow channel. Each nozzle 2 has at least two ejecting apertures 21 on a top and the two ejecting apertures 21 have different spraying directions along the circumferential direction of the nozzle 2, so that a rotation of each nozzle 2 can be driven by the recoil force of the water flow. A top cover 22 is disposed at the top of each nozzle 2. Thus, a gap between the top cover 22 and the periphery wall 2a of corresponding nozzle 2 is defined as an air layer S. The air layer S surrounds the ejecting apertures 21 to supply air to the gap (it is possible to provide an air source for active or passive air supply). The air layer S surrounds the ejecting apertures 21 to supply air to the ejecting apertures 21 so as to form an ejecting water column with bubbles ejected from each ejecting aperture 21. Specifically, the top cover 22 has at least two ejecting holes 221 each facing the corresponding ejecting aperture 21 of each nozzle 2 below. A second gap 200 for allowing air to be sucked into the ejecting water column from each ejecting aperture 21 in an ejecting state is formed between each ejecting hole 221 and the corresponding ejecting aperture 21. That is, the passive air supply natural air supply is achieved because of the second gap 200, without providing a separate air source for active air supply. The plurality of spray holes 221 and the second gap 200 form a second air entrapping mechanism. Similarly, according to the Venturi effect, when the water column passes through the ejecting apertures 21 and the ejecting holes 221, negative pressure will be generated in the second gap 200, so that air around the water column will be sucked into the water column to form the spray water column with bubbles. When the spray water column hits a surface of the object to be cleaned, the stripping force to the pollutants can be increased at the moment when the bubbles are broken. A spray water column is formed by the spray arm body through the first air entrapping mechanism, and a spray water column is formed by the nozzle through the second air entrapping mechanism. Thus, the cleaning effect is further improved through the double air entrapping mechanisms.

A top surface of the top cover 22 is gradually inclined downward from a center to a periphery to form a flow-guiding surface. Under such a design, the top surface of the top cover 22 can be maintained in a state of no water or little water, thus preventing water stains from being sucked into the second gap 200 and affecting the air entrapping effect of the second air entrapping mechanism.

The nozzle 2 has a water inlet 23 and a water inlet sleeve 24 extending downward and surrounding the water inlet 23 on a bottom of the nozzle 2, and a plurality of clamping pins 25 is disposed at a bottom edge of the water inlet sleeve 24. Each clamping pin 25 can pass through the corresponding water outlet 14 to resist against a top surface of the flow channel 11 so as to rotatably constrain the nozzle 2 on the spray arm body 1, so that is convenient for the nozzle 2 to be rotatably disposed on the spray arm A. An outer sidewall of each clamping pin 25 is gradually inclined outward from top to bottom in a radial direction to form a flow-guiding slope 251, thereby reducing energy loss of fluid entering the nozzle 2 in the flow channel 11.

In this embodiment, the spray arm body 1 has the two nozzles 2 respectively arranged at each of the two ends of the spray arm body 1. Each nozzle 2 is capable of rotating together with the spray arm A and rotating relative to the spray arm A, so it is advantageous for eliminating the hard-to-reach corners to be cleaned. The water column with bubbles sprayed out is formed through the air entrapping mechanisms, and the bubbles in the water flow will be broken at the moment when the water column with bubbles comes into contact with pollutants, so that the stripping force to the pollutants on the surface of the object to be cleaned can be increased, and the cleaning effect can be further improved. Moreover, since each nozzle 2 is disposed outside the top plate 3, it can avoid sheltering food residues and silts at a gap between each nozzle and the top plate, and the stability of the rotation of the nozzle can be improved.

It should be noted that in the description and claims of the present invention, the terms used to indicate direction, such as “front, back”, “up, down”, “left, right”, “side, top, bottom”, etc. are used to describe structures and elements of the present invention for better explanation. And these terms used here are based on an orientation in the accompanying drawings. Since the embodiments disclosed by the present invention can be set in different directions, these terms indicating directions are only used as explanations and should not be used as restrictions. For example, the verbs “up”, “down” should not be limited to the direction opposite or consistent with the gravity.

1. A spray arm for a cleaning machine, comprising:
a spray arm body (1) having a top surface and two ends;
one or more nozzles (2) each having a periphery wall (2a);
wherein,
the spray arm body (1) has a plurality of water spray holes (13) and one or more water outlets (14), each nozzle (2) is rotatably disposed on the spray arm body (1) and communicates with one corresponding water outlet (14);
each nozzle (2) has one or more ejecting apertures (21), an air layer(S) is formed adjacent to the periphery wall (2a) of each nozzle (2) and surrounds the one or more ejecting apertures (21) to supply air to an ejecting water column passing through each ejecting aperture (21), so as to form an ejecting water column with bubbles ejected from each ejecting aperture (21).

2. The spray arm of claim 1, wherein a top cover (22) spaced apart from the periphery wall (2a) of each nozzle (2) is connected to each nozzle (2), the top cover (22) has one or more ejecting holes (221) each facing the corresponding ejecting aperture (21) of each nozzle (2) below;
a second gap (200) for allowing air to be sucked into the ejecting water column from each ejecting aperture (21) in an ejecting state is formed between each ejecting hole (221) and the corresponding ejecting aperture (21).

3. The spray arm of claim 1, wherein the spray arm body (1) has a top surface, an air collection chamber (30) is formed at the top surface of the spray arm body (1), the air collection chamber (30) surrounds the plurality of water spray holes (13) to supply air to a spraying water column passing through each water spray hole (13), so as to add bubbles to each spray water column from each water spray hole (13).

4. The spray arm of claim 3, wherein a top plate (3) spaced apart from the top surface of the spray arm body (1) is disposed on the spray arm body (1), the air collection chamber (30) is defined between the top plate (3) and the top surface of the spray arm body (1);
the top plate (3) has a plurality of jet holes (31) each corresponding to each of the plurality of water spray holes (13), a first gap (100) is formed between each jet hole (31) and the corresponding water spray hole (13) for allowing air to be sucked into the spray water column passing through each water spray hole (13) in a spraying state;
the air collection chamber (30), the plurality of jet holes (31) and the first gap (100) form a first air entrapping mechanism.

5. The spray arm of claim 4, wherein the plurality of spray holes (221) and the second gap (200) form a second air entrapping mechanism for forming a spray water column with bubbles sprayed from each spray hole (221).

6. The spray arm of claim 3, wherein the spray arm body (1) has a lengthwise direction and a middle portion, two nozzles (2) are respectively disposed at each end of the spray arm body (1) in the same direction lengthwise of the spray arm body (1), the air collection chamber (30) extends from the middle portion to two ends of the spray arm body (1) and is located between the two nozzles (2).

7. The spray arm of claim 1, wherein the spray arm body (1) has a hollow flow channel (11) communicating with the one or more water outlets (14), the spray arm body (1) has one or more mounting recesses (20) each for receiving the corresponding nozzle (2), and each mounting recess (20) has a semi-enclosed edge and an opening (26) opposite to the semi-enclosed edge.

8. The spray arm of claim 7, wherein the opening (26) of each mounting recess (20) exposes a part of the annular periphery wall (2a) of each nozzle (2) mounted on the corresponding mounting recess (20), an arc length of the exposed part of each annular periphery wall (2a) of each nozzle (2) is 20% to 80% of a circumferential length of each nozzle (2).

9. The spray arm of claim 8, wherein the arc length of the part of the annular periphery wall (2a) of each nozzle (2) exposed at the opening (26) of each mounting recess (20) is 30% to 50% of the circumferential length of each nozzle (2).

10. The spray arm of claim 7, wherein the mounting recess (20) is located at each end of the spray arm body (1), the opening (26) of each mounting recess (20) faces outside from the end of the spray arm body (1).

11. The spray arm of claim 10, wherein each nozzle (2) is disc-shaped, each end of the spray arm body (1) is formed into an arc-shaped end wall (18) corresponding to an outer edge of the nozzle (2) which is located above the spray arm body (1);
the top plate (3) has two end portions, and each end portion of the top plate (3) is recessed inward to form an arc-shaped notch (32) that partially surrounds the nozzle (2) and matches the nozzle (2), the mounting recess (20) is partially enclosed by the arc-shaped notch (32) and the top wall of the spray arm body (1) on an outer side of the spray arm body (1).

12. The spray arm of claim 11, wherein the opening of each mounting recess (20) is defined as an air inlet of the air collection chamber (30).

13. The spray arm of claim 11, wherein the top plate (3) spaced apart from the top wall of the spray arm body (1) is disposed above the top wall of the spray arm body (1), an air collection chamber (30) is defined between the top plate (3) and the top wall of the spray arm body (1), the top plate (3) has a plurality of jet holes (31) each corresponding to the water spray hole (13), a first gap (100) for allowing air to be sucked into a spray water column in a spraying state is existed between each jet hole (31) and the corresponding water spray hole (13).

14. The spray arm of claim 13, wherein a plurality of support ribs (33) for supporting the top plate (3) on the spray arm body (1) is disposed below the top plate (3).

15. The spray arm of claim 14, wherein at least a portion of each support rib (33) is arc-shaped and extends along an edge of the arc-shaped notch (32) below the top plate (3), each support rib (33) has two ends and a gap (331) for allowing air to enter the air collecting chamber (30) from the outside exists between at least one end of the support rib (33) and an inner wall of the air collecting chamber (30).

16. The spray arm of claim 12, wherein the spray arm body (1) has an inclined diversion plane (181) at each end of the spray arm body (1) which gradually inclines downward radially from an edge of a top of the arc-shaped end wall (18).

17. The spray arm of claim 7, wherein when the spray arm is fully assembled, a top surface of each nozzle (2) is flush with the top surface of the spray arm body (1).

18. The spray arm of claim 7, wherein when the spray arm is fully assembled, a thickness of the nozzle (2) is 0.5 to 1.5 times of a depth of the semi-enclosed mounting recess (20).

19. A cleaning machine, comprising:
a box (1′) having a bottom; and
the spray arm (A) of claim 1;
wherein,
the spray arm (A) is rotatably disposed inside the box (1′).

20. The cleaning machine of claim 19, further comprising a filter plate (12′), the box (1′) has a water return region (11′) recessed downward from the bottom of the box (1′), the filter plate (12′) covers the water return region (11′), and the spray arm (A) is located above the filter plate (12′).

21. The cleaning machine of claim 19 is a dishwasher or a fruit and vegetable cleaning machine.
